(19) United States
(12) Patent Application Publication
(10) Pub. No.: US 2025/0111346 A1
(43) Pub. Date: Apr. 3, 2025

(54) VIRTUAL REALITY PRODUCTIVITY ENVIRONMENT IN A CLOUD- CONNECTED AUTONOMOUS VEHICLE

(71) Applicant: Micron Technology, Inc., Boise, ID (US)

(72) Inventors: Mohad Baboli, Boise, ID (US); John Hopkins, Meridian, ID (US)

(21) Appl. No.: 18/775,071

(22) Filed: Jul. 17, 2024

Related U.S. Application Data
(60) Provisional application No. 63/541,563, filed on Sep. 29, 2023.

(51) Int. Cl. G06Q 20/10; G06Q 10/02; G06Q 10/0639; G06Q 30/0283; G06Q 50/47; G06V 20/59; G06V 40/20; H04L 43/0876; H04L 67/50

(52) U.S. Cl. CPC G06Q 20/10; G06Q 10/02; G06Q 10/0639; G06Q 30/0284; G06Q 50/47; G06V 20/59; G06V 40/20; H04L 43/0876; H04L 67/535

(57) ABSTRACT

A system and method for determining a ride fare for a ride in a network-connected autonomous vehicle is disclosed. The system may divide an overall ride fare between the rider, and the enterprise or company at which the rider is employed, where the amounts allocated to each are dependent upon a productivity metric indicating a measure of the work performed by the rider during the ride. Accordingly, the system receives a ride request over a network and calculates an overall ride fare using ride parameters. At the ride's conclusion, the system receives a productivity metric indicating rider productivity enabled by the vehicle's virtual work environment. The system uses the productivity metric to calculate a portion of the overall fare allocated to the rider's account. The virtual environment may include network connectivity, input devices, displays, and cloud-based productivity software. A productivity sensing system generates the productivity metric by monitoring network traffic, or monitoring software application interactions.

### PRIORITY APPLICATION

This application claims the benefit of priority to U.S. Provisional Application Ser. No. 63/541,563, filed Sep. 29, 2023, which is incorporated herein by reference in its entirety.

### BACKGROUND

In the not-too-distant future, significant technological advancements in specific areas such as sensor technologies, machine learning (e.g., computer vision algorithms), and related technology fields, are expected to usher in an era of self-driving cars. These self-driving vehicles, commonly known as autonomous vehicles (AVs), have the potential to revolutionize the way we interact with transportation, leading to a potential decrease in individual car ownership. Instead, it is anticipated that people will increasingly rely on robot vehicles or self-driving taxis for their transportation needs.

One of the key advantages of this transformative shift towards autonomous vehicles is the potential for individuals to reclaim the time they would have otherwise spent driving. With the burden of driving lifted, passengers will have the opportunity to engage in various activities during their journeys, including reading for pleasure, playing games, conducting personal and/or work-related communications, and other work-related tasks, thus transforming their commutes into leisure time, or productive and valuable time.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates an example of a computing environment within which an autonomous vehicle may operate, consistent with some examples.

FIG. 2 illustrates, at a high level, some of the various operations or steps that occur during a ride, by a rider, in an autonomous vehicle, consistent with some examples.

FIG. 3 illustrates an example of a user interface for a virtual productivity environment that may be provided by a head-worn device, or via computing resources provided within the interior cabin of an autonomous vehicle, consistent with some examples.

FIG. 4 illustrates a method for determining a ride fare-specifically, based on a productivity metric derived for a rider, consistent with some examples.

FIG. 5 illustrates a mobile computing device showing a user interface via which an explanation of a ride fare is presented to a rider, consistent with some examples.

FIG. 6 illustrates an example system including a host device and a storage device.

FIG. 7 illustrates a block diagram of an example machine upon which any one or more of the techniques discussed herein may perform.

### DETAILED DESCRIPTION

The present inventors have recognized, among other things, that employees of companies, enterprises and organizations are, now more than ever before, performing work-related tasks outside of traditional office environments (e.g., company, enterprise, and/or government offices). As remote and flexible work arrangements become more common, business executives are looking for new ways to support employees in being productive outside the office. Autonomous vehicles present an opportunity to transform commute time into productive time by offering in-vehicle productivity tools. The motivation for offering in-vehicle productivity tools is to enable employees to make use of commute time for work, leading to higher employee efficiency and productivity. Additionally, in-vehicle productivity tools may generally appeal to workers and help to both attract and retain talent. Furthermore, the more productive that employees are outside of the office, the lower the costs are to employers in providing physical office spaces in which employees work.

In order to motivate workers to perform work-related tasks while riding in autonomous vehicles, the present inventors have recognized that it may be desirable for employers to pay, fully or partially, the ride fare of an employee, when the employee is riding via a ride service while performing work during his or her ride. Offering fare reimbursements based on measured in-ride productivity incentivizes employees to utilize the in-vehicle work environments. For example, when ride fares are discounted or reimbursed, based on work performed during a ride, employees are encouraged to perform work tasks versus just relaxing or engaging in leisure activities during rides. This leads to more output for the company and employees are rewarded for being productive during the ride-time. Additionally, fare sharing agreements offset commuting costs for employees if they can work and earn subsidized fares.

To that end, embodiments of the present invention involve an autonomous vehicle ride service that includes a cloud-based fleet management service for managing a fleet of network-connected autonomous vehicles. Each network-connected autonomous vehicle is equipped to provide a productivity environment, which in some examples, is provided in a virtual reality or augmented reality experience. When a rider initially requests a ride, various parameters-including the pick-up and destination locations—are used in determining an initial overall ride fare. Alternatively, the overall ride fare may be determined at the conclusion of a ride. In either case, during the ride, a work monitoring and/or productivity sensing system detects various interactions that the rider has with the productivity environment that is facilitated by the autonomous vehicle. The productivity sensing system generates a productivity metric, indicating a measure of the productivity of the rider during the ride. Accordingly, at the conclusion of the ride, the productivity metric is used in a calculation to determine what portion of the overall ride fare is to be allocated to the rider. In general, the greater the level of productivity of the rider as indicated by the productivity metric, the smaller or lower the portion of the overall ride fare will be that is allocated to the rider. The portion of the ride fare remaining, after allocating the first portion to the rider, is then allocated to an account of the employer of the rider.

Consistent with some examples, passengers may have access to a range of computing resources that could be either provided by the individuals themselves, or wholly or partially facilitated by the autonomous vehicle's onboard computing capabilities. Cloud-based computing services may also play a pivotal role in ensuring that passengers have access to robust computational power and seamless network connectivity, enabling each rider to engage in complex tasks and real-time collaborations.

Consistent with some examples, each autonomous vehicle may provide network connectivity, allowing the rider to access network resources including cloud-based productivity software. Accordingly, one way for people to utilize their commute time efficiently is by engaging with work through their own mobile computing devices, such as laptop computers, tablet computers, virtual reality (VR) devices, augmented reality (AR) devices, or mixed reality devices, within the confines of autonomous vehicles.

VR devices completely immerse the user in a simulated environment. The user wears a head-mounted display that blocks out the physical world and fully replaces it with a virtual world. This creates a highly immersive productivity experience where the user can interact with the virtual environment as if it is real.

AR devices overlay digital information and objects onto the user's view of the real world. The user wears a transparent head-mounted display that allows them to still see their surroundings, with virtual elements added on top. This allows for a blended experience of physical reality and computer-generated content.

Mixed reality combines elements of both VR and AR. Mixed reality headsets can display fully virtual environments like VR, while also integrating virtual elements into the real world like AR. The key difference is mixed reality allows real world and virtual objects to interact, rather than just overlaying them.

These head-wearable devices are well-suited for performing work tasks in an autonomous vehicle. Since the vehicle drives itself, the passenger does not need to focus on the road and can instead immerse themselves in a virtual work environment. VR provides a distraction-free space optimized for productivity. The user can bring up multiple virtual screens and interfaces to handle communication, document editing, data analysis, and more. AR allows virtual work tools to be anchored in the physical environment, blending the virtual and real. The user could have a virtual keyboard on their lap or virtual monitors on the vehicle walls and windows. Mixed reality takes this a step further by letting virtual and physical objects interact, such as dragging a virtual document onto a real tablet. Overall, these realities allow productive virtual workspaces tailored to the confined physical environment of a vehicle.

Consistent with some examples, each autonomous vehicle may be configured with additional computing resources, including display monitors and input devices, such that the rider need not bring or provide his or her own computing device(s). With some examples, the autonomous vehicle is equipped with an array of inward-facing cameras and sensors to continuously monitor the interior cabin space. To enable a virtual reality workspace, the vehicle contains a set of mounted displays and projection surfaces, including screens on the side windows, ceiling, and floor areas. Specialized VR software stitches together the live interior camera feeds to create a three-dimensional (“3-D”) model of the cabin space. The software then overlays immersive VR environments onto the 3-D cabin model. These VR environments are rendered on the displays and projection surfaces, surrounding the rider in a seamless virtual workspace. The VR environments simulate a variety of workspaces, such as office, desktop and conference room settings. Virtual monitors, whiteboards, keyboards and other tools could be rendered. The rider can interact with the virtual workspace using gestures, voice commands or AR controllers, such as handheld input devices. The rider's interactions can be detected by the interior cameras and sensors. This approach allows the autonomous vehicle to transform its physical interior into a fully immersive and customizable virtual office tailored to the rider's needs. It creates an enhanced workspace experience compared to simply providing connectivity and tools on the rider's own mobile devices.

Consistent with some examples, the virtual productivity environment that is facilitated by each network-connected autonomous vehicle may be accessible to the rider for an additional fee. For example, the fee may be based on the specific computing resources that are utilized by the rider. If, for example, the rider brings his or her own computing device, the rider may be charged for simply utilizing the network connectivity that is facilitated by the autonomous vehicle. However, if the rider utilizes the hardware computing resources of the autonomous vehicle, the rider may be charged based on the amount of time the resources are in use, or some other metric, such as the amount or network traffic or data processing that has occurred.

The future of self-driving cars holds the promise of transforming mundane commutes into valuable opportunities for productive work engagement. By leveraging virtual reality devices and sophisticated computing resources within autonomous vehicles, individuals can seamlessly blend work activities into their daily travel routines, unlocking new levels of efficiency and convenience. As technological advancements continue to propel us towards this autonomous future, the possibilities for harnessing the potential of virtual reality in the context of self-driving cars are truly boundless.

As described in greater detail below, to encourage people to perform work-related tasks while riding in autonomous vehicles, a ride service may have third-party integration capabilities, such that various companies or enterprises can enter into agreements to have ride fares divided between a rider, and the employer of the rider. In some cases, the overall ride fare for a ride may be divided between the rider, and his or her employer, based on a calculation that takes as input a productivity metric that is determined by a work monitoring or productivity sensing system. The work monitoring or productivity sensing system may be a component of the autonomous vehicle, or it may be partially or wholly integrated via a cloud-based service. In any case, at the completion of a ride, a first portion of the ride fare may be allocated to the rider, based on a calculation that is specified or agreed upon by the employer of the rider, and which takes as input the productivity metric that is determined by the productivity sensing system. By dividing the ride fare in this way, both the rider and his or her employer benefit. Other advantages and aspects of the various embodiments of the invention will be readily apparent from the description of the several figures that follow.

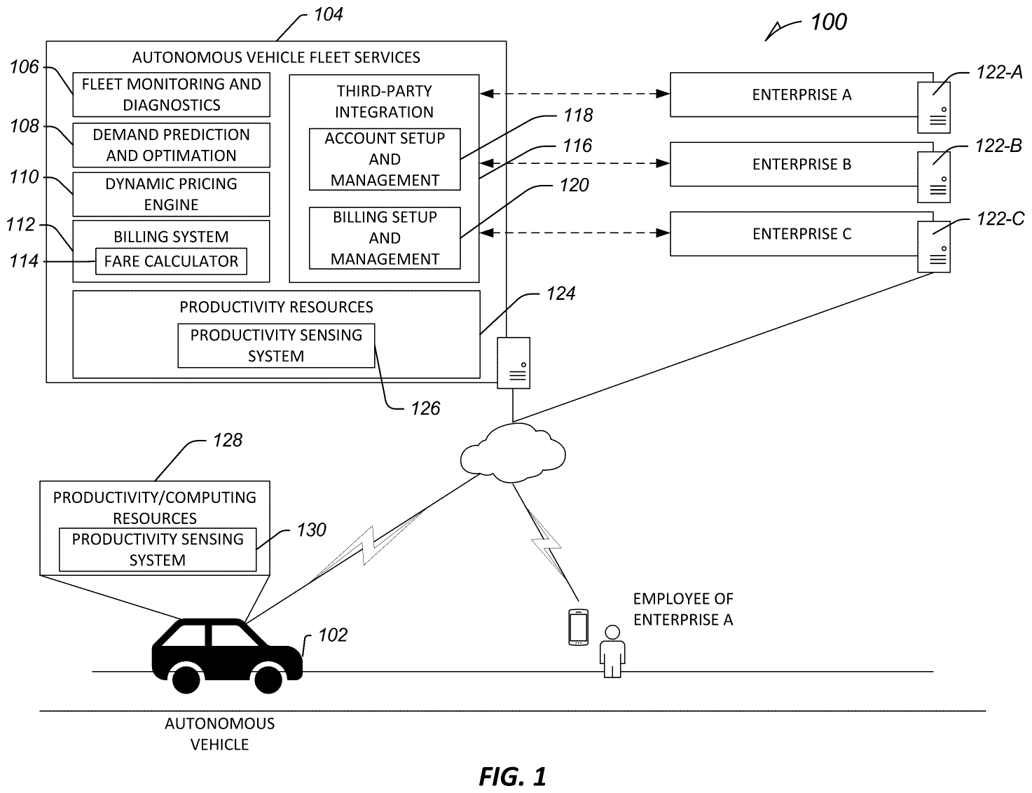

FIG. 1 illustrates an example of a computing environment 100 within which an autonomous vehicle 102 may operate, consistent with some examples. The computing environment 100 depicts various cloud-based services that enable fleet management, ride billing, third-party integrations, and in-vehicle productivity features. The autonomous vehicle fleet services 104 include a third-party integration service, via which various third-party organizations can setup and establish accounts, and configure billing and invoice management for the ride service.

In some examples, a fleet monitoring and diagnostics service 106 is a cloud service that tracks the location and status of each autonomous vehicle in the fleet. It can identify vehicles in need of maintenance or repairs so they can be taken offline. This service 106 ensures the fleet is operating optimally to handle ride demands. By way of example, the fleet monitoring and diagnostics service 106 may leverage GPS tracking and network connections in each autonomous vehicle 102 to monitor real-time locations and operational states of all vehicles in the fleet.

Consistent with some examples, the cloud-based autonomous vehicle fleet services may include a demand prediction and optimization service 108. This service, which may operate in connection with the monitoring and diagnostics service 106, analyzes historical ride patterns plus current conditions to forecast near-term demand across geographic zones. The demand prediction service 108 optimizes real-time dispatching and routing of autonomous vehicles to efficiently meet predicted demand. This allows appropriately positioning the fleet for rider pick-up requests.

In some examples, the demand prediction and optimization service 108 utilizes historical ride data, current traffic and events data, and machine learning algorithms to forecast demand across different zones. It analyzes patterns in popular pick-up and drop-off locations, ride requests at various times and days, and correlations with factors like weather and local events. Using these insights, it models and predicts near-term demand in each zone. It then uses optimization algorithms to determine optimal distributions and routes for autonomous vehicles to meet the predicted demand. The service continuously recalculates these optimizations and dispatches updated instructions to the fleet as actual demand unfolds. This allows dynamically positioning the optimal number of vehicles in each zone to efficiently fulfill incoming ride requests.

In some examples, a dynamic pricing engine 110 leverages real-time data and predictive algorithms to generate a customized fare for each ride request. The dynamic pricing engine may factor in the origin and destination zones as received with the ride request, estimated trip duration based on traffic patterns, and the current balance of supply and demand in those areas. Using machine learning models trained on historical data, the dynamic pricing engine 110 makes short-term predictions about demand spikes and lulls. It may adjust pricing dynamically to disincentivize riders during high demand periods, ensuring adequate supply. Alternatively, it may lower prices during low demand to encourage more ride requests. This automated, data-driven approach to pricing enables optimally balancing supply and demand, providing a pricing mechanism to align rider demand with fleet availability.

In some examples, overall ride fares are determined at the outset of the ride, and then honored, regardless of the actual circumstances. However, in other instances, a predicted ride fare may be presented to the rider, but then adjusted based on the actual circumstances that occur during the ride. For example, if traffic is heavier than predicted, and thus the ride takes longer than expected, the initial predicted overall ride fare may be updated at the conclusion of the ride to take such circumstances into consideration.

In some examples, a billing system 112 handles payment processing for completed rides. The billing system 112 may determine overall ride fares based on a number of factors, including the origin, destination, time travelled, and other parameters. The overall ride fare may be predicted, and provided, at the start of a ride. Alternatively, in some examples, a predicted overall ride fare may be presented at the start of a ride, but then adjusted to account for the actual circumstances of the ride.

In some examples, the billing system 112 integrates with the third-party integration service 116, such that the fare calculator 114 calculates each ride fare, in part, based on billing setup parameters that are established by various third-party organizations and enterprises. For example, as described in greater detail below, the third-party integration service 116 facilitates billing arrangements that involve subsidized ride or fare sharing programs for enterprise employees. Accordingly, in some cases, the fare calculator 114 will calculate an overall ride fare, but then apportion a first part of the ride fare to the rider, while apportioning the remaining portion of the ride fare to an associated enterprise (e.g., the rider's employer), based on measured productivity during the ride.

The third-party integration service 116 enables integrating the ride service platform with external entities like companies, enterprises, and organizations (e.g., private, public and government entities). Through an account setup and management service 118, the third-party integration service 116 allows for customized account setup. Specifically, each enterprise (e.g., enterprise A 122-A, enterprise B 122-B, and enterprise C 122-C) is provided with access to a portal for the ride service, providing a user interface via which an authorized representative of the enterprise can establish a corporate or enterprise account and then allow employees to link individual accounts with the corporate or enterprise account. Similarly, a billing setup and management service 120 allows each enterprise to establish and configure employee ride subsidization or fare sharing policies, for example.

In some examples, each autonomous vehicle 102 may provide productivity and computing resources 128. These resources may encompass the in-vehicle virtual productivity environment(s) made available to riders. This includes onboard computers, displays, headsets, collaboration tools, cloud-based apps, and any other productivity-enhancing features. The autonomous vehicle 102 provides network connectivity for riders to utilize these resources. As illustrated in FIG. 1, in some examples, the productivity and computing resources 128 provided via the network-connected autonomous vehicle 102 may be closely integrated with cloud-based productivity resources 124, in some instances, to include a suite of productivity software applications. Although not illustrated in FIG. 1, in some examples, the fleet services 104 may be configured to allow network access to each rider to access a suite of cloud-based software applications provided or hosted by another entity, such as the employer of the rider.

In some examples, the cloud-connected autonomous vehicle 102 includes work monitoring or a productivity sensing system or logic 130 capable of monitoring rider interactions with the in-vehicle productivity resources 128. As shown in FIG. 1, the productivity sensing logic 130 may be implemented, in part, via the autonomous vehicle 102, but also via a cloud-based component 126. In either case, the productivity sensing logic 126 and 130 generates productivity metrics indicating how much time riders spend performing work-related activities, or how much effort and concentration is directed to work-related activities. These productivity metrics help quantify rider productivity, which the billing system 112 factors into the fare allocation calculations between riders and their associated employer-enterprises.

In some examples, the productivity sensing system 126 and 130 monitors rider interactions within the virtual productivity environment. The productivity sensing system may use a variety of sensors and analytics to detect work-related usage. For example, the system may track network traffic to identify usage of work-related sites and cloud-based apps. In some examples, the productivity sensing system may also use interior cameras and computer vision algorithms to recognize work gestures and behaviors. Microphones may detect work-related conversations and speech commands. Input devices can be monitored for document editing actions. The system combines data from these sensors to accurately recognize time spent on work tasks versus leisure activities.

The productivity sensing system 126 and 130 allows quantifying work time and generating one or more productivity metrics to inform fare allocation decisions or calculations. By continuously monitoring rider actions through multiple sensor channels, the system can provide a holistic view of work activity throughout the trip. The ride service provider can customize sensitivity thresholds to fine-tune what interactions are classified as productive work versus non-work. This allows accurately incentivizing work engagement via fare adjustments based on real-time effort.

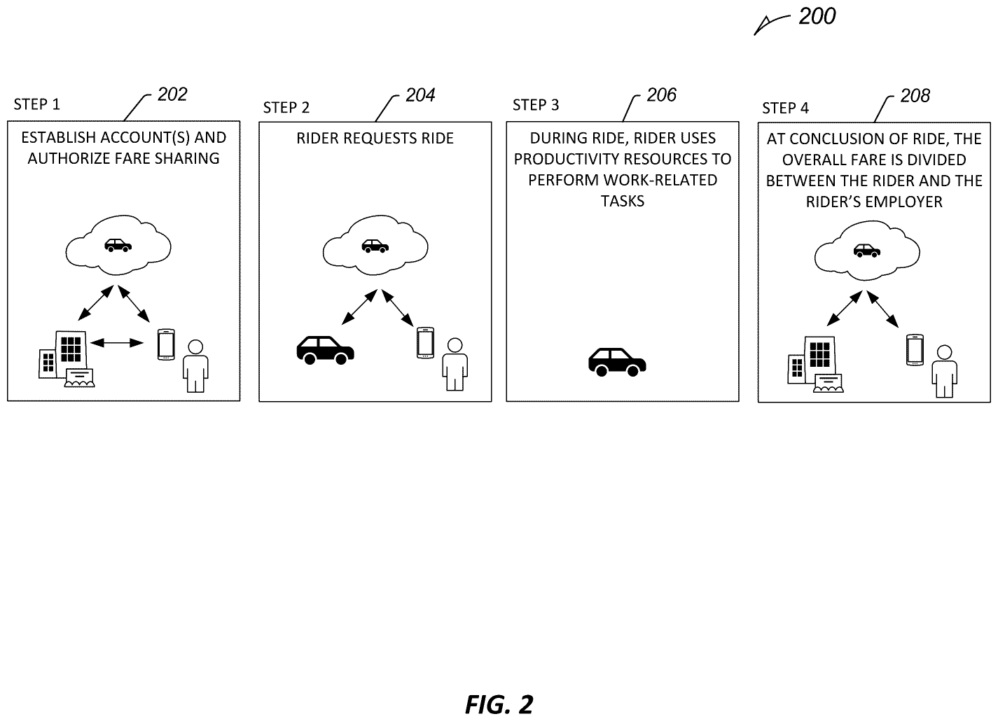

FIG. 2 illustrates, at a high level, some of the various operations or steps that occur when a rider rides in an autonomous vehicle, and a ride fare is determined, consistent with some examples. As illustrated in FIG. 2, during a first step 202, a rider and a representative of his or her employer establish respective accounts with the ride service. For instance, in some examples, to utilize the autonomous vehicle ride service's enterprise fare subsidization or fare sharing model, a multi-step account setup process may be required. First, an authorized representative from the enterprise registers for a corporate account with the ride service provider. The enterprise representative provides details like company name, address, contact info, and number of employees. Next, individual employees of that enterprise sign up for their own personal accounts and associate them with the enterprise's corporate account. There are at least two ways this might occur. First, when creating their account, employees may search and select their employer from a directory to link the accounts. Alternatively, an employee-rider may register or sign-up first, and then send an invitation to their employer to create a corporate account linked to their personal account.

Once the corporate account is established, the enterprise representative configures their fare subsidization agreement and ride cost allocation rules. This specifies how ride fares will be divided between the enterprise and employee based on measured employee productivity during the ride. For example, each enterprise may set a rule that the enterprise covers a certain percent (e.g., 80%) of fare costs if the rider's productivity score exceeds a threshold. In some examples, the ride fare allocation calculation may be dependent upon the nature or type of work detected, as well as the time or duration of work performed, relative to the time or duration of the actual ride. For example, in some instances, document analysis and editing may be weighted more heavily than participating in an audio or video-based communication session with a coworker. In some examples, the details and logic of the fare split calculation can be customized per enterprise. Accordingly, a representative from each participating enterprise may access a rider service portal to configure the ride fare calculation.

After the enterprise and rider accounts have been established, and the enterprise fare sharing agreement has been specified, during the second step, with reference number 204, a rider requests a ride via his or her personal account. In some examples, a rider may use a mobile application provided by the ride service to specify pick-up and drop-off locations, as part of generating the ride request. Accordingly, when the ride request is received and processed by the cloud-based fleet services, an autonomous vehicle will be dispatched to the pick-up location. Alternatively, in some examples, an autonomous vehicle may include a user interface and input mechanisms, such that a rider can enter a parked autonomous vehicle, and then specify a particular location to be dropped-off.

In some examples, riders may authenticate with the autonomous vehicle service through their personal mobile device or wearable technology. This links the physical ride to their account for billing purposes. When entering the vehicle, the rider may scan a QR code or tap their phone/watch on an NFC tag. This will check the rider into the ride session. The vehicle communicates the authentication back to the ride provider's servers in the cloud. This allows identifying the individual rider account to charge, along with any linked enterprise account if ride fare subsidies will be applied. Additionally, in some examples, rider authentication connects the rider to the in-vehicle productivity features and suite of cloud-based apps. Usage of these productivity tools may incur an additional fee on top of just the ride fare. By authenticating, the rider agrees to pay these potential productivity service fees. The applicable accounts linked to the authenticated rider are charged appropriately following the ride. This streamlined authentication mechanism provides seamless billing across multiple accounts per ride without the rider needing to manually enter payment details or account information.

As shown in FIG. 2 at step 3 with reference 206, during the ride, a rider may leverage productivity and computing resources facilitated by the network-connected autonomous vehicle, to perform work-related tasks. The actions of the rider are monitored by the productivity sensing system or logic.

Finally, at step 4 with reference number 208, at the conclusion of the ride, an overall ride fare is determined. This overall ride fare may be for just the ride, or it may include both the ride fare and any incurred fee(s) for the rider using the built-in productivity tools of the autonomous vehicle. In either case, a productivity metric is reported to the billing system, so that a first portion of the overall ride fare can be determined, based on the productivity metric, and then allocated to the rider. The remaining portion of the overall ride fare is allocated to the enterprise or corporate account, associated with the rider's individual account.

In some examples, the ride fare calculation will be performed by a cloud-based service. However, in some examples, each autonomous vehicle may have computing and software resources for generating the fare, which would then be communicated to the rider over a network.

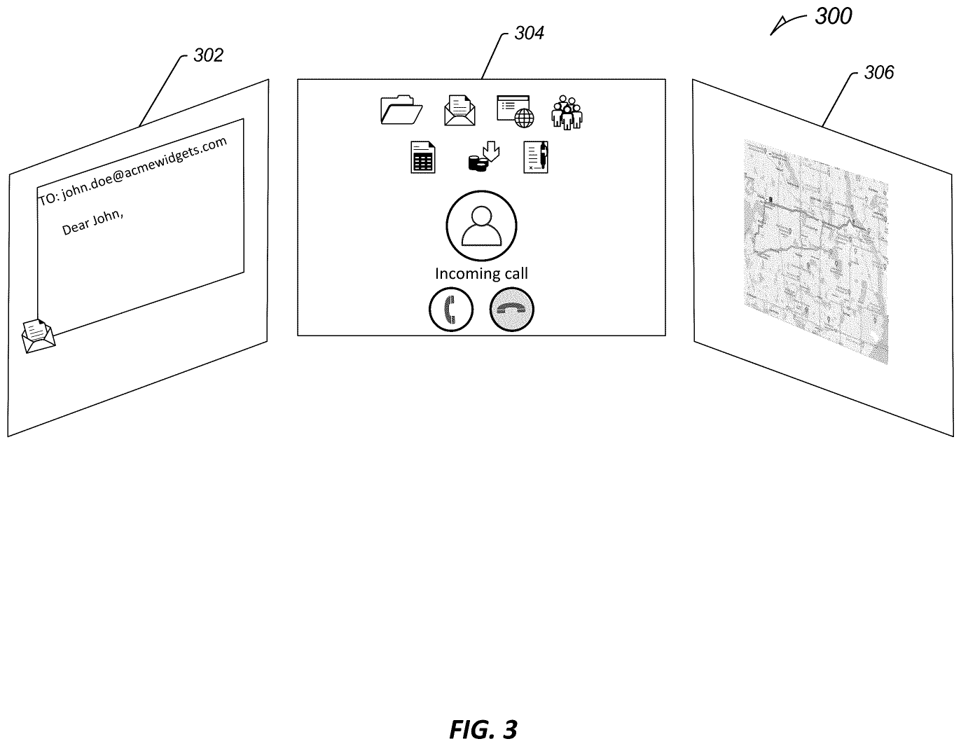

FIG. 3 illustrates an example of a virtual productivity environment that may be provided by a head worn device, or via computing resources provided within the interior cabin of an autonomous vehicle, consistent with some examples. In some examples, the autonomous vehicle provides a virtual work or productivity environment, using augmented reality displays projected into the interior of the vehicle. These virtual displays allow the rider to multitask across various productivity applications and tools. In other instances, a rider may wear a head-worn augmented reality, virtual reality or mixed reality device.

As shown in FIG. 3, there are three main virtual displays that have been generated. The left display 302 shows an email drafting application via which the rider can prepare an email for communicating to a client or co-worker. This allows composing new messages, responding to received emails, and general email management.

The middle display 304 shows a home screen of app icons, representing a suite of cloud-based productivity software available to the rider. Selecting an icon opens that application. The bottom of this display shows an incoming video call notification, allowing the rider to accept the call, and participate in a video-conferencing session. At least in some examples, the network-connected autonomous vehicle may include one or more cameras, microphones, and speakers, for facilitating the video-conferencing session.

The virtual display 306 positioned to the right is showing a real-time trip progress screen. In some examples, this provides current location on a map, along with origin, destination, estimated time remaining, mileage, fare information, and so forth.

In some examples, these virtual displays are projected into the rider's field of view using augmented reality. However, the rider sees the real physical environment of the car interior with these overlays added on top. Alternatively, in some examples, the displays may be actual displays, and not virtual displays, presented via hardware monitors or displays positioned within the autonomous vehicle.

In some examples, the displays are managed through hand gestures tracked by sensors built into the vehicle. For example, the rider can perform a hand gesture to select or grab and reposition the screens in 3-D space to customize their layout. This creates an immersive workspace optimized for productivity on the go, allowing enterprise-connected riders to utilize commute time efficiently.

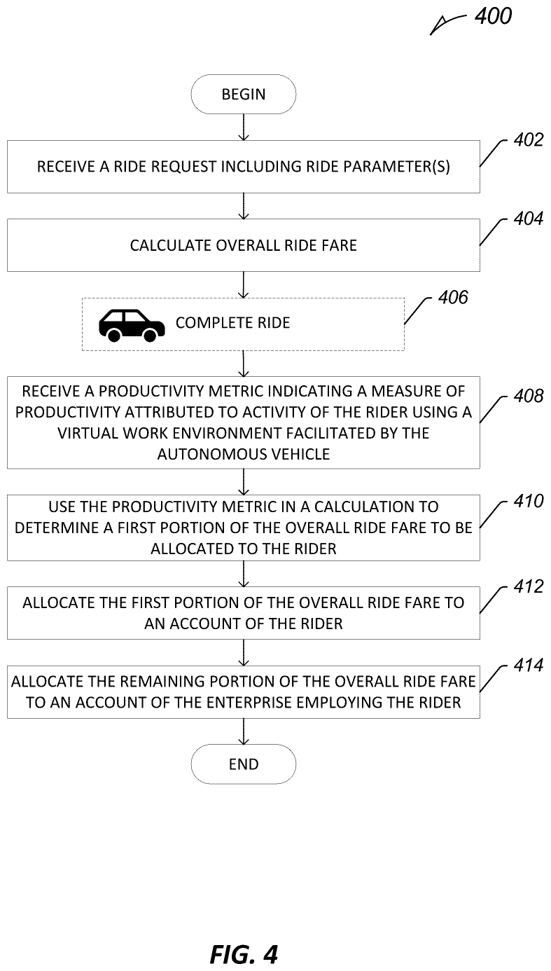

FIG. 4 illustrates a method for determining a rider fare, consistent with some examples. At method operation 402, a ride request is received. The ride request may be invoked using a mobile application. Accordingly, at least in some instances, the rider may not be near an autonomous vehicle when the request is initiated and sent. The ride request may be received via a cloud-connected fleet management service. The ride request may specify parameters, such as a desired size of requested vehicle, a pick-up time and location, a drop-off location, preferred productivity tools to be present in the autonomous vehicle, and potentially other parameters.

Next, at method operation 404, upon receiving the ride request, an overall ride fare is calculated and communicated back to a device of the rider. In some instances, the overall ride fare may be set prior to the ride, and then honored regardless of what actually occurs during the ride. In other instances, a ride fare range may be specified up front (e.g., prior to the ride), and then finalized at the conclusion of the ride. In some examples, overall ride fares may be set based on a schedule that specifies a specific fare based on the distance traveled, duration of the ride, number of different predetermined zones that are traversed, or some combination. In some instances, the overall ride fare may be computed and presented only upon completion of the ride.

In any case, as shown with reference 406, after requesting the ride and before a ride fare is allocated to the rider, the rider completes the ride, and in some cases, performs various work-related tasks via a virtual productivity environment that is facilitated by the autonomous vehicle. During the ride, a productivity sensing system will monitor the actions of the rider for purposes of generating one or more productivity metrics.

At method operation 408, upon receiving the productivity metric, or in some instances, multiple productivity metrics, a first portion of the overall ride fare is determined using as input to the calculation at least the productivity metric or metrics. The productivity metric is a key input into the fare allocation calculation between the rider and their employer. There are a few ways it can be incorporated.

If the productivity metric is a percentage of time spent working, that percentage could directly determine the fare split. For example, if the rider spent 80% of the trip working, 80% of the fare could be allocated to the employer and 20% to the rider. In another example, the percentage could also be mapped to fare allocation tiers. For example, 70-79% productivity=60/40 employer/rider split, 80-89%=70/30 split, 90-100%=80/20 split. In yet another example, if the productivity metric accounts for weighting of different activity types, the weighted score could determine the allocation. For example, a score of 85 could map to a 75/25 split. In yet another example, the enterprise could define fare subsidy levels tied to ranges of productivity scores. For example, scores 0-50 mean no subsidy, 51-75 means 50% subsidy, 76-100 means 80% subsidy. In yet another example, the enterprise could set a minimum productivity threshold that must be met for any subsidy, like 60%. Below that, the rider pays 100% of fare. Ultimately, the ride service provider gives enterprises flexibility to customize the mapping between productivity metrics and fare allocation percentages. This allows tailoring incentives to their specific workflows and priorities. The above-mentioned fare calculations are just some of the many possibilities that could be implemented, consistent with different embodiments of the invention.

At method operation 412, the first portion of the ride fare is allocated to the rider (e.g., the account of the rider), and in method operation 414, the remaining portion of the overall ride fare—that amount remaining after allocating the first portion to the rider—is allocated to the account of the enterprise that is employing the rider, as indicated by the linkage of accounts.

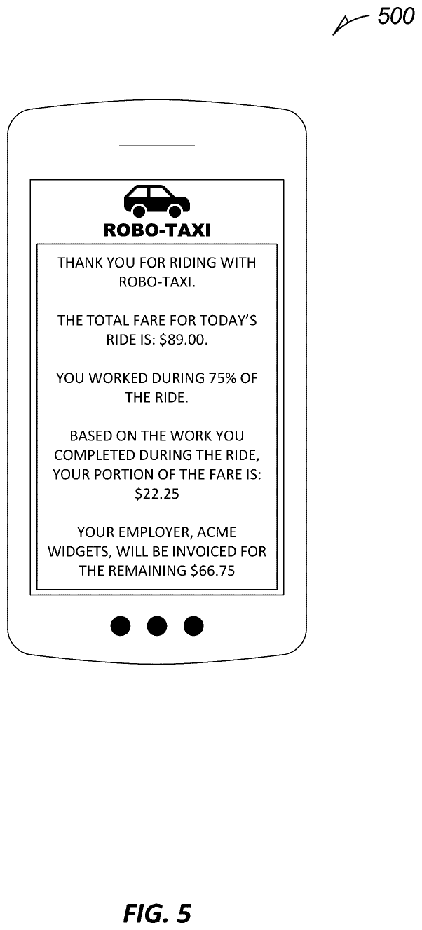

FIG. 5 illustrates an example of a user interface for the ride service's mobile app displaying, at the end of a ride, a ride fare summary. The user interface 500 provides a breakdown of the ride fare and how it was allocated between the rider and the rider's employer. Specifically, the example user interface shows the overall or total ride fare. This is the upfront base fare calculated for the full ride based on trip details like distance, time, traffic, and so forth. In the example, it shows $89.00. The example user interface also shows the rider's fare portion. This is the part of the total or overall fare that was allocated to the rider's personal account. Based on their in-ride productivity, it shows the rider was allocated $22.25. The example user interface shows the productivity score. In this example, the productivity score is reported as a percentage of time worked, during the ride. In other examples, the productivity metric may be reported differently, for example, expressed on a scale of 0-100. In the example, the productivity score indicates the rider was productive for 75% of the total trip time. This gives context on what level of productivity led to the allocated fare amounts. Finally, the example user interface shows the portion of the overall ride fare allocated to the company or enterprise—in this case, $66.75. This breakdown provides transparency to the rider on how much they will pay personally versus their employer. The productivity score offers clear context on how their effort during the ride impacted the fare allocation.

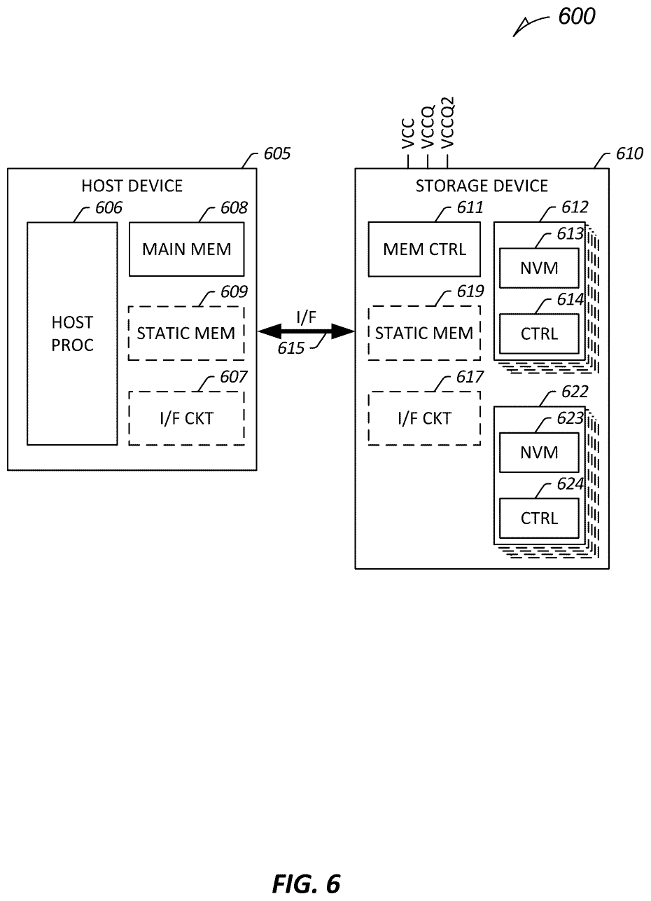

FIG. 6 illustrates an example system 600 (e.g., a host system or processor system) including a host device 605 and a storage device 610 configured to communicate over a communication interface (I/F) 615 (e.g., a bidirectional parallel or serial communication interface). In an example, the communication interface 615 can be referred to as a host interface. The host device 605 can include a host processor 606 (e.g., a host central processing unit (CPU) or other processor or processing circuitry, such as a memory management unit (MMU), interface circuitry, etc.). In certain examples, the host device 605 can include a main memory (MAIN MEM) 608 (e.g., DRAM, etc.) and optionally, a static memory (STATIC MEM) 609, to support operation of the host processor (HOST PROC) 606.

The storage device 610 can include a non-volatile memory device, in certain examples, a single device separate from the host device 605 and components of the host device 605 (e.g., including components illustrated in FIG. 6), in other examples, a component of the host device 605, and in yet other examples, a combination of separate discrete components. For example, the communication interface 615 can include a serial or parallel bidirectional interface, such as defined in one or more Joint Electron Device Engineering Council (JEDEC) standards.

The storage device 610 can include a memory controller (MEM CTRL) 611 and a first non-volatile memory device 612. The memory controller 611 can optionally include a limited amount of static memory 619 (or main memory) to support operations of the memory controller 611. In an example, the first non-volatile memory device 612 can include a number of non-volatile memory devices (e.g., dies or LUNs), such as one or more stacked flash memory devices (e.g., as illustrated with the stacked dashes underneath the first non-volatile memory device 612), etc., each including non-volatile memory (NVM) 613 (e.g., one or more groups of non-volatile memory cells) and a device controller (CTRL) 614 or other periphery circuitry thereon (e.g., device logic, etc.), and controlled by the memory controller 611 over an internal storage-system communication interface (e.g., an Open NAND Flash Interface (ONFI) bus, etc.) separate from the communication interface 615. Control circuitry, as used herein, can refer to one or more of the memory controller 611, the device controller 614, or other periphery circuitry in the storage device 610, the NVM device 612, etc.

Flash memory devices typically include one or more groups of one-transistor, floating gate (FG) or replacement gate (RG) (or charge trapping) storage structures (memory cells). The memory cells of the memory array are typically arranged in a matrix. The gates of each memory cell in a row of the array are coupled to an access line (e.g., a word line). In NOR architecture, the drains of each memory cell in a column of the array are coupled to a data line (e.g., a bit line). In NAND architecture, the drains of each memory cell in a column of the array are coupled together in series, source to drain, between a source line and a bit line. Each memory cell in a NOR, NAND, 3D XPoint, FeRAM, MRAM, or

one or more other architecture semiconductor memory array can be programmed individually or collectively to one or a number of programmed states. A single-level cell (SLC) can represent one bit of data per cell in one of two programmed states (e.g., 1 or 0). A multi-level cell (MLC) can represent two or more bits of data per cell in a number of programmed states (e.g., 2n, where n is the number of bits of data). In certain examples, MLC can refer to a memory cell that can store two bits of data in one of 4 programmed states. A triple-level cell (TLC) can represent three bits of data per cell in one of 8 programmed states. A quad-level cell (QLC) can represent four bits of data per cell in one of 16 programmed states. In other examples, MLC can refer to any memory cell that can store more than one bit of data per cell, including TLC and QLC, etc.

In three-dimensional (3D) architecture semiconductor memory device technology, memory cells can be stacked, increasing the number of tiers, physical pages, and accordingly, the density of memory cells in a memory device. Data is often stored arbitrarily on the storage system as small units. Even if accessed as a single unit, data can be received in small, random 4-16 k single file reads (e.g., 60%-80% of operations are smaller than 16k). It is difficult for a user and even kernel applications to indicate that data should be stored as one sequential cohesive unit. File systems are typically designed to optimize space usage, and not sequential retrieval space.

The memory controller 611, separate from the host processor 606 and the host device 605, can receive instructions from the host device 605, and can communicate with the first non-volatile memory device 612, such as to transfer data to (e.g., write or erase) or from (e.g., read) one or more of the memory cells of the first non-volatile memory device 612. The memory controller 611 can include, among other things, circuitry or firmware, such as a number of components or integrated circuits. For example, the memory controller 611 can include one or more memory control units, circuits, or components configured to control access across the memory array and to provide a translation layer between the host device 605 and the storage system 600, such as a memory manager, one or more memory management tables, etc.

In an example, the storage device 610 can include a second non-volatile memory device 622, separate from the first non-volatile memory device 612, the second non-volatile memory device 622 can include a number of non-volatile memory devices, etc., each including non-volatile memory 623 and a device controller 624 or other periphery circuitry thereon, and controlled by the memory controller 611 over an internal storage-system communication interface separate from the communication interface 615. In an example, the first non-volatile memory device 612 can be configured as a “cold tier” memory device and the second non-volatile memory device 622 can be configured as a “warm tier” memory device (while the main memory 608, the static memory 609, the static memory 619 (or main memory) can be configured as a “hot tier” memory).

The memory manager can include, among other things, circuitry or firmware, such as a number of components or integrated circuits associated with various memory management functions, including, among other functions, wear leveling (e.g., garbage collection or reclamation), error detection or correction, block retirement, or one or more other memory management functions. The memory manager can parse or format host commands (e.g., commands received from the host device 605) into device commands (e.g., commands associated with operation of a memory array, etc.), or generate device commands (e.g., to accomplish various memory management functions) for the device controller 614 or one or more other components of the storage device 610.

The memory manager can include a set of management tables configured to maintain various information associated with one or more component of the storage device 610 (e.g., various information associated with a memory array or one or more memory cells coupled to the memory controller 611). For example, the management tables can include information regarding block age, block erase count, error history, or one or more error counts (e.g., a write operation error count, a read bit error count, a read operation error count, an erase error count, etc.) for one or more blocks of memory cells coupled to the memory controller 611. In certain examples, if the number of detected errors for one or more of the error counts is above a threshold, the bit error can be referred to as an uncorrectable bit error. The management tables can maintain a count of correctable or uncorrectable bit errors, among other things. In an example, the management tables can include translation tables or a L2P mapping.

The memory manager can implement and use data structures to reduce storage device 610 latency in operations that involve searching L2P tables for valid pages, such as garbage collection. To this end, the memory manager is arranged to maintain a data structure (e.g., table region data structure, tracking data structure, etc.) for a physical block. The data structure includes indications of L2P mapping table regions, of the L2P table. In certain examples, the data structure is a bitmap (e.g., a binary array). In an example, the bitmap includes a bit for each region of multiple, mutually exclusive, regions that span the L2P table.

The first non-volatile memory device 612 or the non-volatile memory 613 (e.g., one or more 3D NAND architecture semiconductor memory arrays) can include a number of memory cells arranged in, for example, a number of devices, planes, blocks, physical pages, super blocks, or super pages. As one example, a TLC memory device can include 18,592 bytes (B) of data per page, 1536 pages per block, 548 blocks per plane, and 4 planes per device. As another example, an MLC memory device can include 18,592 bytes (B) of data per page, 1024 pages per block, 548 blocks per plane, and 4 planes per device, but with half the required write time and twice the program/erase (P/E) cycles as a corresponding TLC memory device. Other examples can include other numbers or arrangements. A super block can include a combination of multiple blocks, such as from different planes, etc., and a window can refer to a stripe of a super block, typically matching a portion covered by a physical-to-logical (P2L) table chunk, etc., and a super page can include a combination of multiple pages.

The term “super” can refer to a combination or multiples of a thing or things. For examples, a super block can include a combination of blocks. If a memory device includes 4 planes, a super block may refer to the same block on each plane, or a pattern of blocks across the panes (e.g., a combination of block 0 on plane 0, block 1 on plane 1, block 2 on plane 2, and block 3 on plane 3, etc.). In an example, if a storage system includes multiple memory devices, the combination or pattern of blocks can extend across the multiple memory devices. The term “stripe” can refer to a pattern of combination or pattern of a piece or pieces of a thing or things. For example, a stripe of a super block can refer to a combination or pattern of pages from each block in the super block.

In operation, data is typically written to or read from the storage device 610 in pages and erased in blocks. However, one or more memory operations (e.g., read, write, erase, etc.) can be performed on larger or smaller groups of memory cells, as desired. For example, a partial update of tagged data from an offload unit can be collected during data migration or garbage collection to ensure it was re-written efficiently. The data transfer size of a memory device is typically referred to as a page, whereas the data transfer size of a host device is typically referred to as a sector. Although a page of data can include a number of bytes of user data (e.g., a data payload including a number of sectors of data) and its corresponding metadata, the size of the page often refers only to the number of bytes used to store the user data. As an example, a page of data having a page size of 4 kB may include 4 kB of user data (e.g., 8 sectors assuming a sector size of 512B) as well as a number of bytes (e.g., 32B, 54B, 224B, etc.) of auxiliary or metadata corresponding to the user data, such as integrity data (e.g., error detecting or correcting code data), address data (e.g., logical address data, etc.), or other metadata associated with the user data.

Different types of memory cells or memory arrays can provide for different page sizes or may require different amounts of metadata associated therewith. For example, different memory device types may have different bit error rates, which can lead to different amounts of metadata necessary to ensure integrity of the page of data (e.g., a memory device with a higher bit error rate may require more bytes of error correction code (ECC) data than a memory device with a lower bit error rate). As an example, an MLC NAND flash device may have a higher bit error rate than a corresponding SLC NAND flash device. As such, the MLC device may require more metadata bytes for error data than the corresponding SLC device.

In an example, the data in a chunk or data unit can be managed in an optimized manner throughout its tenure on the storage system. For example, the data is managed as one unit during data migration (e.g., garbage collection, etc.) such that the efficient read/write properties are preserved as data is moved to its new physical location on the storage system. In certain examples, the only limit to the number of chunks, data units, or blocks configurable for storage, tagging, etc., are the capacities of the system.

One or more of the host device 605 or the storage device 610 can include interface circuitry, such as a host interface circuit (I/F CKT) 707 or a storage interface circuit (I/F CKT) 617, configured to enable communication between components of the host system 600. Each interface circuit can include one or more interconnect layers, such as mobile industry processor interface (MIPI) Unified Protocol (UniPro) and M-PHY layers (e.g., physical layers), including circuit components and interfaces. The M-PHY layer includes the differential transmit (TX) and receive (RX) signaling pairs (e.g., DIN_t, DIN_c and DOUT_t, DOUT_c, etc.). In certain examples, the host interface circuit 707 can include a controller (e.g., a UFS controller), a driver circuit (e.g., a UFS driver), etc. Although described herein with respect to the UniPro and M-PHY layers, one or more other set of circuit components or interfaces can be used to transfer data between circuit components of the host system 600.

Components of the host system 600 can be configured to receive or operate using one or more host voltages, including, for example, VCC, VCCQ, and, optionally, VCCQ2. In certain examples, one or more of the host voltages, or power rails, can be managed or controlled by a power management integrated circuit (PMIC). In certain examples, VCC can be a first supply voltage (e.g., 2.7V-3.3V, 1.7V-1.95V, etc.). In an example, one or more of the static memory 619 or the non-volatile memory devices 612 can require VCC for operation. VCCQ can be a second supply voltage, lower than the VCC (e.g., 1.1V-1.3V, etc.). In an example, one or more of the memory controller 611, the communication interface 615, or memory I/O or other low voltage blocks can optionally require VCCQ for operation. VCCQ2 can be a third supply voltage between VCC and VCCQ (e.g., 1.7V-1.95V, etc.). In an example, one or more of the memory controller 611 of the communication interface, or other low voltage block can optionally require VCCQ2. Each host voltage can be set to provide voltage at one or more current levels, in certain examples, controllable by one or more device descriptors and levels (e.g., between [0:15], each representing a different maximum expected source current, etc.).

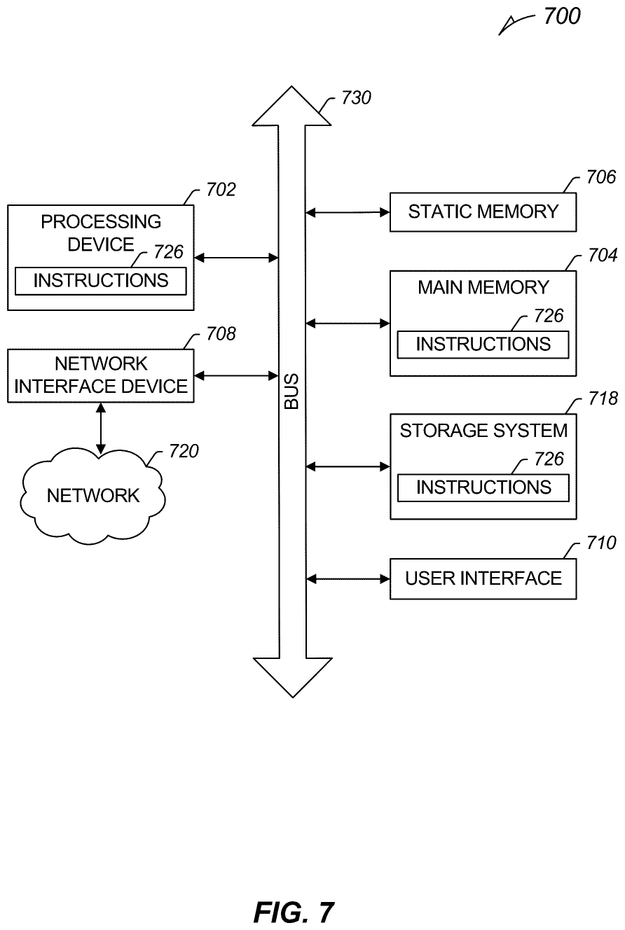

FIG. 7 illustrates a block diagram of an example machine 700 (e.g., a host system) upon which any one or more of the techniques (e.g., methodologies) discussed herein may perform. In alternative embodiments, the machine 700 may operate as a standalone device or may be connected (e.g., networked) to other machines. In a networked deployment, the machine 700 may operate in the capacity of a server machine, a client machine, or both in server-client network environments. In an example, the machine 700 may function as a peer machine in peer-to-peer (P2P) (or other distributed) network environment. The machine 700 may be a personal computer (PC), a tablet PC, a set-top box (STB), a personal digital assistant (PDA), a mobile telephone, a web appliance, an IoT device, automotive system, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (Saas), other computer cluster configurations.

Examples, as described herein, may include, or may operate by, logic, components, devices, packages, or mechanisms. Circuitry is a collection (e.g., set) of circuits implemented in tangible entities that include hardware (e.g., simple circuits, gates, logic, etc.). Circuitry membership may be flexible over time and underlying hardware variability. Circuitries include members that may, alone or in combination, perform specific tasks when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a computer-readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable participating hardware (e.g., the execution units or a loading mechanism) to create members of the circuitry in hardware via the variable connections to carry out portions of the specific tasks when in operation. Accordingly, the computer-readable medium is communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time.

The machine 700 (e.g., computer system, a host system, etc.) may include a processing device 702 (e.g., a hardware processor, a central processing unit (CPU), a graphics processing unit (GPU), a hardware processor core, or any combination thereof, etc.), a main memory 704 (e.g., read-only memory (ROM), dynamic random-access memory (DRAM), a static memory 706 (e.g., static random-access memory (SRAM), etc.), and a storage system 818, some or all of which may communicate with each other via a communication interface 830 (e.g., a bus).

The processing device 702 can represent one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. The processing device 702 can also be one or more special-purpose processing devices such as an application specific integrated circuit (ASIC), a field programmable gate array (FPGA), a digital signal processor (DSP), network processor, or the like. The processing device 702 can be configured to execute instructions 726 for performing the operations and steps discussed herein. The machine 700 can further include a network interface device 708 to communicate over a network 720.

The storage system 718 can include a machine-readable storage medium (also known as a computer-readable medium) on which is stored one or more sets of instructions 726 or software embodying any one or more of the methodologies or functions described herein. The instructions 726 can also reside, completely or at least partially, within the main memory 704 or within the processing device 702 during execution thereof by the machine 700, the main memory 704 and the processing device 702 also constituting machine-readable storage media.

The term “machine-readable storage medium” should be taken to include a single medium or multiple media that store the one or more sets of instructions, or any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media. In an example, a massed machine-readable medium comprises a machine-readable medium with a plurality of particles having invariant (e.g., rest) mass. Accordingly, massed machine-readable media are not transitory propagating signals. Specific examples of massed machine-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The machine 700 may further include a user interface 710, such as one or more of a display unit, an alphanumeric input device (e.g., a keyboard), and a user interface (UI) navigation device (e.g., a mouse), etc. In an example, one or more of the display unit, the input device, or the UI navigation device may be a touch screen display. The machine a signal generation device (e.g., a speaker), or one or more sensors, such as a global positioning system (GPS) sensor, compass, accelerometer, or one or more other sensor. The machine 700 may include an output controller, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The instructions 726 (e.g., software, programs, an operating system (OS), etc.) or other data are stored on the storage system 718 can be accessed by the main memory 704 for use by the processing device 702. The main memory 704 (e.g., DRAM) is typically fast, but volatile, and thus a different type of storage than the storage system 718 (e.g., an SSD), which is suitable for long-term storage, including while in an “off” condition. The instructions 726 or data in use by a user or the machine 700 are typically loaded in the main memory 704 for use by the processing device 702. When the main memory 704 is full, virtual space from the storage system 718 can be allocated to supplement the main memory 704; however, because the storage system 718 device is typically slower than the main memory 704, and write speeds are typically at least twice as slow as read speeds, use of virtual memory can greatly reduce user experience due to storage system latency (in contrast to the main memory 704, e.g., DRAM). Further, use of the storage system 718 for virtual memory can greatly reduce the usable lifespan of the storage system 718.

The instructions 724 may further be transmitted or received over a network 720 using a transmission medium via the network interface device 708 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi, IEEE 802.16 family of standards known as WiMax), IEEE 802.15.4 family of standards, peer-to-peer (P2P) networks, among others. In an example, the network interface device 708 may include one or more physical jacks (e.g., Ethernet, coaxial, or phone jacks) or one or more antennas to connect to the network 720. In an example, the network interface device 708 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 700, and includes digital or analog communications signals or other intangible medium to facilitate communication of such software.

The above detailed description includes references to the accompanying drawings, which form a part of the detailed description. The drawings show, by way of illustration, specific embodiments in which the invention can be practiced. These embodiments are also referred to herein as examples. Such examples can include elements in addition to those shown or described. However, the present inventor also contemplates examples in which only those elements shown or described are provided. Moreover, the present inventor also contemplates examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein”. Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

In various examples, the components, controllers, processors, units, engines, or tables described herein can include, among other things, physical circuitry or firmware stored on a physical device. As used herein, “processor” means any type of computational circuit such as, but not limited to, a microprocessor, a microcontroller, a graphics processor, a digital signal processor (DSP), or any other type of processor or processing circuit, including a group of processors or multi-core devices.

As used herein, directional adjectives, such as horizontal, vertical, normal, parallel, perpendicular, etc., can refer to relative orientations, and are not intended to require strict adherence to specific geometric properties, unless otherwise noted. It will be understood that when an element is referred to as being “on,” “connected to” or “coupled with” another element, it can be directly on, connected, or coupled with the other element or intervening elements may be present. In contrast, when an element is referred to as being “directly on,” “directly connected to” or “directly coupled with” another element, there are no intervening elements or layers present. If two elements are shown in the drawings with a line connecting them, the two elements can be either be coupled, or directly coupled, unless otherwise indicated.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, the code can be tangibly stored on one or more volatile or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

Embodiments may be implemented in one or a combination of hardware, firmware, and software. Embodiments may also be implemented as instructions stored on a machine-readable storage device, which may be read and executed by at least one processor to perform the operations described herein. A machine-readable storage device may include any non-transitory mechanism for storing information in a form readable by a machine (e.g., a computer). For example, a machine-readable storage device may include read-only memory (ROM), random-access memory (RAM), magnetic disk storage media, optical storage media, flash-memory devices, and other storage devices and media.

A processor subsystem may be used to execute the instruction on the-readable medium. The processor subsystem may include one or more processors, each with one or more cores. Additionally, the processor subsystem may be disposed on one or more physical devices. The processor subsystem may include one or more specialized processors, such as a graphics processing unit (GPU), a digital signal processor (DSP), a field programmable gate array (FPGA), or a fixed function processor.

Examples, as described herein, may include, or may operate on, logic or a number of components, modules, or mechanisms. Modules may be hardware, software, or firmware communicatively coupled to one or more processors in order to carry out the operations described herein. Modules may be hardware modules, and as such modules may be considered tangible entities capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software; the general-purpose hardware processor may be configured as respective different modules at different times. Software may accordingly configure a hardware processor, for example, to constitute a particular module at one instance of time and to constitute a different module at a different instance of time. Modules may also be software or firmware modules, which operate to perform the methodologies described herein.

As used in any embodiment herein, the term “logic” may refer to firmware or circuitry configured to perform any of the aforementioned operations. Firmware may be embodied as code, instructions or instruction sets, as data hard-coded (e.g., nonvolatile) in memory devices or circuitry, or combinations thereof.

“Circuitry,” as used in any embodiment herein, may comprise, for example, any combination or permutation of hardwired circuitry, programmable circuitry, state machine circuitry, logic, or firmware that stores instructions executed by programmable circuitry. The circuitry may be embodied as an integrated circuit, such as an integrated circuit chip. In some embodiments, the circuitry may be formed, at least in part, by the processor circuitry executing code or instruction sets (e.g., software, firmware, etc.) corresponding to the functionality described herein, thus transforming a general-purpose processor into a specific-purpose processing environment to perform one or more of the operations described herein. In some embodiments, the processor circuitry may be embodied as a stand-alone integrated circuit or may be incorporated as one of several components on an integrated circuit. In some embodiments, the various components and circuitry of the node or other systems may be combined in a system-on-a-chip (SoC) architecture.

### EXAMPLES

Example 1 is a system for determining a ride fare for a ride in a network-connected autonomous vehicle, the system comprising: a processor; and a memory storage device storing executable instructions thereon, which, when executed by the processor, cause the system to perform operations comprising: receiving, over a network, a ride request including one or more ride parameters for a ride in the network-connected autonomous vehicle; calculating an overall ride fare for the ride; receiving a productivity metric indicating a measure of productivity attributed to activity of a rider using a virtual work environment facilitated by the network-connected autonomous vehicle; using the productivity metric in a calculation to determine a first portion of the overall ride fare to be allocated to the rider; and allocating the first portion of the overall ride fare to an account of the rider.

In Example 2, the subject matter of Example 1 includes, wherein the rider is an employee of a first enterprise and, prior to using the productivity metric in the calculation to determine the first portion of the overall ride fare to be allocated to the rider: receiving, over a network, an indication of approval for using the calculation to determine an amount of a ride fare for a rider employed by the enterprise.

In Example 3, the subject matter of Example 2 includes, wherein the memory storage device is storing additional executable instructions thereon, which, when executed by the processor, cause the system to perform additional operations comprising: allocating to an account of the enterprise a second portion of the ride fare, the second portion being the amount of the overall ride fare remaining after allocating the first portion to the rider.

In Example 4, the subject matter of Examples 1-3 includes, wherein the virtual work environment facilitated by the network-connected autonomous vehicle comprises: a network connectivity service facilitated by the autonomous vehicle and for use by the rider in connecting a computing device to a public network; an input device and one or more displays providing the rider with access to a suite of cloud-based productivity software applications; and a combination thereof.

In Example 5, the subject matter of Examples 1-4 includes, wherein the activity attributed to the rider using the virtual work environment is determined by a productivity sensing system of the network-connected autonomous vehicle, the productivity sensing system configured to generate the productivity metric by: monitoring network traffic associated with a network connection provided by the autonomous vehicle to determine an amount of the network traffic associated with work being performed by the rider, wherein the productivity metric is based on the amount of network traffic.

In Example 6, the subject matter of Examples 1-5 includes, wherein the activity attributed to the rider using the virtual work environment is determined by a productivity sensing system of the network-connected autonomous vehicle, the productivity sensing system configured to generate the productivity metric by: capturing images of the rider within the interior of the autonomous vehicle using one or more image sensors; providing the captured images as input to a pre-trained computer vision model that is configured to analyze the captured images and determine, based on analysis of the captured images, when the rider is performing work within the virtual work environment; generating the productivity metric based on output of the pre-trained computer vision model indicating an amount of time the rider was determined to be performing work within the virtual work environment.

In Example 7, the subject matter of Examples 1-6 includes, wherein the virtual work environment facilitated by the network-connected autonomous vehicle includes a suite of cloud-based productivity software applications associated with a service of the autonomous vehicle and the activity attributed to the rider using the virtual work environment is determined by a productivity sensing system of the network-connected autonomous vehicle, the productivity sensing system configured to generate the productivity metric by: monitoring interactions by the rider with the cloud-based productivity software applications, wherein interactions include launching applications, opening documents, editing documents, sending communications through applications, and accessing application features.

In Example 8, the subject matter of Example 7 includes, wherein the productivity sensing system is configured to generate the productivity metric by: determining an amount of time the rider interacts with the cloud-based productivity software applications based on the monitored interactions; wherein generating the productivity metric is based on the percentage of time during the ride that the rider is determined to be interacting with the cloud-based productivity software applications.

In Example 9, the subject matter of Examples 1-8 includes, wherein the memory storage device is storing additional executable instructions thereon, which, when executed by the processor, cause the system to perform additional operations comprising: at the conclusion of the ride, communicating a message to a computing device of the rider, the message specifying i) the overall ride fare, ii) the first portion of the overall ride fare allocated to the account of the rider, iii) a value for the productivity metric, and iv) an indication that the overall ride fare was reduced based on the value of the productivity metric.

Example 10 is a method for determining a ride fare for a ride in a network-connected autonomous vehicle, the method comprising: receiving, over a network, a ride request including one or more ride parameters for a ride in the network-connected autonomous vehicle; using at least the one or more ride parameters, calculating an overall ride fare for the ride; and at the conclusion of the ride, i) receiving a productivity metric indicating a measure of productivity attributed to activity of a rider using a virtual work environment facilitated by the network-connected autonomous vehicle, ii) using the productivity metric in a calculation to determine a first portion of the overall ride fare to be allocated to the rider, and iii) allocating the first portion of the overall ride fare to an account of the rider.

In Example 11, the subject matter of Example 10 includes, wherein the rider is an employee of a first enterprise and, prior to using the productivity metric in the calculation to determine the first portion of the overall ride fare to be allocated to the rider: receiving, over a network, an indication of approval for using the calculation to determine an amount of a ride fare for a rider employed by the enterprise.

In Example 12, the subject matter of Example 11 includes, allocating to an account of the enterprise a second portion of the ride fare, the second portion being the amount of the overall ride fare remaining after allocating the first portion to the rider.

In Example 13, the subject matter of Examples 10-12 includes, wherein the virtual work environment facilitated by the network-connected autonomous vehicle comprises: a network connectivity service facilitated by the autonomous vehicle and for use by the rider in connecting a computing device to a public network; an input device and one or more displays providing the rider with access to a suite of cloud-based productivity software applications; and a combination thereof.

In Example 14, the subject matter of Examples 10-13 includes, wherein the activity attributed to the rider using the virtual work environment is determined by a productivity sensing system of the network-connected autonomous vehicle, the productivity sensing system configured to generate the productivity metric by: monitoring network traffic associated with a network connection provided by the autonomous vehicle to determine an amount of the network traffic associated with work being performed by the rider, wherein the productivity metric is based on the amount of network traffic.

In Example 15, the subject matter of Examples 10-14 includes, wherein the activity attributed to the rider using the virtual work environment is determined by a productivity sensing system of the network-connected autonomous vehicle, the productivity sensing system configured to generate the productivity metric by: capturing images of the rider within the interior of the autonomous vehicle using one or more image sensors; providing the captured images as input to a pre-trained computer vision model that is configured to analyze the captured images and determine, based on analysis of the captured images, when the rider is performing work within the virtual work environment; generating the productivity metric based on output of the pre-trained computer vision model indicating an amount of time the rider was determined to be performing work within the virtual work environment.

In Example 16, the subject matter of Examples 10-15 includes, wherein the virtual work environment facilitated by the network-connected autonomous vehicle includes a suite of cloud-based productivity software applications associated with a service of the autonomous vehicle and the activity attributed to the rider using the virtual work environment is determined by a productivity sensing system of the network-connected autonomous vehicle, the productivity sensing system configured to generate the productivity metric by: monitoring interactions by the rider with the cloud-based productivity software applications, wherein interactions include launching applications, opening documents, editing documents, sending communications through applications, and accessing application features.

In Example 17, the subject matter of Example 16 includes, wherein the productivity sensing system is configured to generate the productivity metric by: determining an amount of time the rider interacts with the cloud-based productivity software applications based on the monitored interactions; wherein generating the productivity metric is based on the percentage of time during the ride that the rider is determined to be interacting with the cloud-based productivity software applications.

In Example 18, the subject matter of Examples 10-17 includes, at the conclusion of the ride, communicating a message to a computing device of the rider, the message specifying i) the overall ride fare, ii) the first portion of the overall ride fare allocated to the account of the rider, iii) a value for the productivity metric, and iv) an indication that the overall ride fare was reduced based on the value of the productivity metric.

Example 19 is a system for determining a ride fare for a ride in a network-connected autonomous vehicle, the system comprising: means for receiving, over a network, a ride request including one or more ride parameters for a ride in the network-connected autonomous vehicle; means for using at least the one or more ride parameters to calculate an overall ride fare for the ride; and means for, at the conclusion of the ride, i) receiving a productivity metric indicating a measure of productivity attributed to activity of a rider using a virtual work environment facilitated by the network-connected autonomous vehicle, ii) using the productivity metric in a calculation to determine a first portion of the overall ride fare to be allocated to the rider, and iii) allocating the first portion of the overall ride fare to an account of the rider.

In Example 20, the subject matter of Example 19 includes, means for capturing images of the rider within the interior of the autonomous vehicle using one or more image sensors; means for providing the captured images as input to a pre-trained computer vision model that is configured to analyze the captured images and determine, based on analysis of the captured images, when the rider is performing work within the virtual work environment; means for generating the productivity metric based on output of the pre-trained computer vision model indicating an amount of time the rider was determined to be performing work within the virtual work environment.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

What is claimed is:

1. A system for determining a ride fare for a ride in a network-connected autonomous vehicle, the system comprising:
a processor; and
a memory storage device storing executable instructions thereon, which, when executed by the processor, cause the system to perform operations comprising:
receiving, over a network, a ride request including one or more ride parameters for a ride in the network-connected autonomous vehicle;
calculating an overall ride fare for the ride;
receiving a productivity metric indicating a measure of productivity attributed to activity of a rider using a virtual work environment facilitated by the network-connected autonomous vehicle;
using the productivity metric in a calculation to determine a first portion of the overall ride fare to be allocated to the rider; and
allocating the first portion of the overall ride fare to an account of the rider.

2. The system of claim 1, wherein the rider is an employee of a first enterprise and, prior to using the productivity metric in the calculation to determine the first portion of the overall ride fare to be allocated to the rider:
receiving, over a network, an indication of approval for using the calculation to determine an amount of a ride fare for a rider employed by the enterprise.

3. The system of claim 2, wherein the memory storage device is storing additional executable instructions thereon, which, when executed by the processor, cause the system to perform additional operations comprising:
allocating to an account of the enterprise a second portion of the ride fare, the second portion being the amount of the overall ride fare remaining after allocating the first portion to the rider.

4. The system of claim 1, wherein the virtual work environment facilitated by the network-connected autonomous vehicle comprises:
a network connectivity service facilitated by the autonomous vehicle and for use by the rider in connecting a computing device to a public network;
an input device and one or more displays providing the rider with access to a suite of cloud-based productivity software applications; and
a combination thereof.

5. The system of claim 1, wherein the activity attributed to the rider using the virtual work environment is determined by a productivity sensing system of the network-connected autonomous vehicle, the productivity sensing system configured to generate the productivity metric by:
monitoring network traffic associated with a network connection provided by the autonomous vehicle to determine an amount of the network traffic associated with work being performed by the rider, wherein the productivity metric is based on the amount of network traffic.

6. The system of claim 1, wherein the activity attributed to the rider using the virtual work environment is determined by a productivity sensing system of the network-connected autonomous vehicle, the productivity sensing system configured to generate the productivity metric by:
capturing images of the rider within the interior of the autonomous vehicle using one or more image sensors;
providing the captured images as input to a pre-trained computer vision model that is configured to analyze the captured images and determine, based on analysis of the captured images, when the rider is performing work within the virtual work environment;
generating the productivity metric based on output of the pre-trained computer vision model indicating an amount of time the rider was determined to be performing work within the virtual work environment.

7. The system of claim 1, wherein the virtual work environment facilitated by the network-connected autonomous vehicle includes a suite of cloud-based productivity software applications associated with a service of the autonomous vehicle and the activity attributed to the rider using the virtual work environment is determined by a productivity sensing system of the network-connected autonomous vehicle, the productivity sensing system configured to generate the productivity metric by:
monitoring interactions by the rider with the cloud-based productivity software applications, wherein interactions include launching applications, opening documents, editing documents, sending communications through applications, and accessing application features.

8. The system of claim 7, wherein the productivity sensing system is configured to generate the productivity metric by:
determining an amount of time the rider interacts with the cloud-based productivity software applications based on the monitored interactions;
wherein generating the productivity metric is based on the percentage of time during the ride that the rider is determined to be interacting with the cloud-based productivity software applications.

9. The system of claim 1, wherein the memory storage device is storing additional executable instructions thereon, which, when executed by the processor, cause the system to perform additional operations comprising:
at the conclusion of the ride, communicating a message to a computing device of the rider, the message specifying i) the overall ride fare, ii) the first portion of the overall ride fare allocated to the account of the rider, iii) a value for the productivity metric, and iv) an indication that the overall ride fare was reduced based on the value of the productivity metric.

10. A method for determining a ride fare for a ride in a network-connected autonomous vehicle, the method comprising:
receiving, over a network, a ride request including one or more ride parameters for a ride in the network-connected autonomous vehicle;
using at least the one or more ride parameters, calculating an overall ride fare for the ride; and
at the conclusion of the ride, i) receiving a productivity metric indicating a measure of productivity attributed to activity of a rider using a virtual work environment facilitated by the network-connected autonomous vehicle, ii) using the productivity metric in a calculation to determine a first portion of the overall ride fare to be allocated to the rider, and iii) allocating the first portion of the overall ride fare to an account of the rider.

11. The method of claim 10, wherein the rider is an employee of a first enterprise and, prior to using the productivity metric in the calculation to determine the first portion of the overall ride fare to be allocated to the rider:
receiving, over a network, an indication of approval for using the calculation to determine an amount of a ride fare for a rider employed by the enterprise.

12. The method of claim 11, further comprising:
allocating to an account of the enterprise a second portion of the ride fare, the second portion being the amount of the overall ride fare remaining after allocating the first portion to the rider.

13. The method of claim 10, wherein the virtual work environment facilitated by the network-connected autonomous vehicle comprises:
a network connectivity service facilitated by the autonomous vehicle and for use by the rider in connecting a computing device to a public network;
an input device and one or more displays providing the rider with access to a suite of cloud-based productivity software applications; and
a combination thereof.

14. The method of claim 10, wherein the activity attributed to the rider using the virtual work environment is determined by a productivity sensing system of the network-connected autonomous vehicle, the productivity sensing system configured to generate the productivity metric by:
monitoring network traffic associated with a network connection provided by the autonomous vehicle to determine an amount of the network traffic associated with work being performed by the rider, wherein the productivity metric is based on the amount of network traffic.

15. The method of claim 10, wherein the activity attributed to the rider using the virtual work environment is determined by a productivity sensing system of the network-connected autonomous vehicle, the productivity sensing system configured to generate the productivity metric by:
capturing images of the rider within the interior of the autonomous vehicle using one or more image sensors;
providing the captured images as input to a pre-trained computer vision model that is configured to analyze the captured images and determine, based on analysis of the captured images, when the rider is performing work within the virtual work environment;
generating the productivity metric based on output of the pre-trained computer vision model indicating an amount of time the rider was determined to be performing work within the virtual work environment.

16. The method of claim 10, wherein the virtual work environment facilitated by the network-connected autonomous vehicle includes a suite of cloud-based productivity software applications associated with a service of the autonomous vehicle and the activity attributed to the rider using the virtual work environment is determined by a productivity sensing system of the network-connected autonomous vehicle, the productivity sensing system configured to generate the productivity metric by:
monitoring interactions by the rider with the cloud-based productivity software applications, wherein interactions include launching applications, opening documents, editing documents, sending communications through applications, and accessing application features.

17. The method of claim 16, wherein the productivity sensing system is configured to generate the productivity metric by:
determining an amount of time the rider interacts with the cloud-based productivity software applications based on the monitored interactions;
wherein generating the productivity metric is based on the percentage of time during the ride that the rider is determined to be interacting with the cloud-based productivity software applications.

18. The method of claim 10, further comprising:
at the conclusion of the ride, communicating a message to a computing device of the rider, the message specifying i) the overall ride fare, ii) the first portion of the overall ride fare allocated to the account of the rider, iii) a value for the productivity metric, and iv) an indication that the overall ride fare was reduced based on the value of the productivity metric.

19. A system for determining a ride fare for a ride in a network-connected autonomous vehicle, the system comprising:
means for receiving, over a network, a ride request including one or more ride parameters for a ride in the network-connected autonomous vehicle;
means for using at least the one or more ride parameters to calculate an overall ride fare for the ride; and
means for, at the conclusion of the ride, i) receiving a productivity metric indicating a measure of productivity attributed to activity of a rider using a virtual work environment facilitated by the network-connected autonomous vehicle, ii) using the productivity metric in a calculation to determine a first portion of the overall ride fare to be allocated to the rider, and iii) allocating the first portion of the overall ride fare to an account of the rider.

20. The system of claim 19, further comprising:
means for capturing images of the rider within the interior of the autonomous vehicle using one or more image sensors;
means for providing the captured images as input to a pre-trained computer vision model that is configured to analyze the captured images and determine, based on analysis of the captured images, when the rider is performing work within the virtual work environment;
means for generating the productivity metric based on output of the pre-trained computer vision model indicating an amount of time the rider was determined to be performing work within the virtual work environment.
